(19) United States
(12) Patent Application Publication
(10) Pub. No.: US 2010/0174602 A1
(43) Pub. Date: Jul. 8, 2010

(54) Methods and systems for providing targeted marketing over the internet

(75) Inventors: Monte Zweben, San Mateo, CA (US); James D. Norman, San Francisco, CA (US)

Correspondence Address: Law Office of Scott C Harris Inc, PO Box 1389, Rancho Santa Fe, CA, 92067, US

(73) Assignee: BLUE MARTINI SOFTWARE, INC

(21) Appl. No.: 12/717,192

(22) Filed: Mar. 4, 2010

Related U.S. Application Data
(62) Division of application No. 10/370,108, filed on Feb. 21, 2003, now abandoned.
(60) Provisional application No. 60/357,876, filed on Feb. 21, 2002.

(51) Int. Cl. G06F 15/173; G06Q 30/00

(52) U.S. Cl. 705/14.41; 709/224; 705/14.53; 709/225

(57) ABSTRACT

A system, method and computer-readable medium for providing customized content to at least one prospective customer are disclosed. In one embodiment, the method includes the step of creating a personalized portal page in a database by aggregating corporate information relevant to a prospect's business interest. Next, the method directs the personalized portal page to the prospect. Once the prospect accesses the portal and reviews the content, the present system then gathers prospect behavior data. Next, a report based on the prospect behavior data is generated, and then the personalized portal page is modified in response to the behavior data.

### RELATED APPLICATIONS

This application claims priority from the following U.S. Provisional Application, the disclosure of which is incorporated by reference in its entirety for all purposes: U.S. Provisional Application Ser. No. 60/357,876 to Monte Zweben et al., entitled, “System and Method for Providing Targeted Marketing Over the Internet,” filed Feb. 21, 2002.

### DESCRIPTION OF THE INVENTION

1. Field of the Invention

The present invention relates to systems and methods for providing product and services marketing, and, more particularly, to systems and methods for online marketing of potential prospects.

2. Background of the Invention

Browser applications have become ubiquitous tools for accessing the vast amounts of information that are available via computer networks, such as the Internet and the like. At its basic level of operation, the browser permits a user to connect to a given network site, and download informational content from that site, such as an HTML document, for display at the user's computer. To view additional information, or a different type of information, the user designates a new network address, e.g. a different HTML file, whose contents then replace the previously displayed information on the user's computer.

When users access a particular site, they all too often are inundated with information that is of no interest to the user. Sometimes, the layout of the web site and the additional information may actually distract the user to such a degree as to prevent them from accessing and viewing the desired information. This is particularly troublesome for online marketers who rely heavily on their ability to communicate product and service information to potential prospects. In the past, when a marketer directed a potential prospect to a corporate web site, the prospect invariably was forced to sift through additional material not directly relevant to the prospect's interest and/or the marketer's product. Sometimes this additional information confused and frustrated the prospect to such a degree as to cause them to lose interest in the marketer's product and possibly even pursue other avenues to fulfill their needs. The marketer's themselves were also frustrated with modern corporate web sites. Not only were they unable to control the presentation of the material to the user, but they also could not assess the effectiveness of the material presented to the user.

In an effort to alleviate the need for users to navigate from one network site to another, web developers implemented portals to more actively control a user's access to information. In general, a portal is an entry point or gateway for access to Internet web sites, or the like. One of the prominent advantages of a portal is the fact that information stored at a plurality of different network addresses, including different sites, can be simultaneously viewed on the display, rather than limiting the user to information from one site at a time. Most companies and organizations provide different types of portals for a variety of purposes, including portals for the general public, intranet portals for their employees, and extranet portals for their customers, vendors, suppliers and other parties with whom they transact business.

Instead of reducing the amount of information that is presented to a user, these prior art portals actually sought to increase the amount of information that a user may access from a single web page. From one standpoint, these prior art portals are an improvement over conventional web pages because they allow developers to more tightly control a user's access to information. On the other hand, these portals are more problematic since they do not limit extraneous information to which a user may be exposed. Further complicating the problem for marketers is the fact that modern web developers have been slow to develop portal applications that will allow a user to access a portal site via several different handheld devices (e.g., cellular telephone, wireless Palm, pager, or Blackberry).

While the organizational needs served by a portal continue to grow, so have the complexity and cost of developing, deploying, administering and continually enhancing portals. To maintain the continued interest of portal users, administrators must carry out an ongoing effort to maintain portal content that is fresh, deep, customizable and sufficiently broad that their constituents will consider them to be a meaningful gateway to the Internet. Consequently, companies and organizations are forced to either maintain staffs of highly skilled engineers and content developers, or to outsource these tasks. Meanwhile, Internet-related technologies are proliferating and maturing, and Internet users' expectations continue to increase. Maintaining an effective personalized marketing portal often competes with and detracts from the resources available for an organization's primary goals. For these reasons, there is a need to provide a personal communication channel to an audience where information is a vital part of the relationship and greatly varies per audience member. For example: (1) Sales wants to communicate and provide information to prospects non-intrusively over a long complex sales cycle; (2) Customer Service wants to provide personalized portals of their complex and vast product documentation to their customers; (3) Manufacturing wants to create product portals for their resellers, introducing new product lines; and (4) Human Resources provides a portal of company and job position information to an applicant.

There is also a need for a system and method that allows non-programmers to develop and implement portals for other users.

In addition, there is further a need to provide the capability to track and analyze usage of a portal to provide insight to the portal creator how to more effectively provide information to the audience.

### SUMMARY OF THE INVENTION

Systems, methods and computer-readable mediums consistent with the present invention satisfy the above-described need by providing a system and method for providing customized content to at least one prospective customer. In one embodiment, the method includes the step of creating a personalized portal page in a database by aggregating corporate information relevant to a prospect's business interest. Next, the method directs the personalized portal page to the prospect. Once the prospect accesses the portal and reviews the content, the present system then gathers prospect behavior data. Next, a report based on the prospect behavior data is generated, and then the personalized portal page is modified in response to the behavior data.

To facilitate an understanding of the present invention, it is described hereinafter with reference to specific implementations thereof. For example, the software programs that underlie the invention can be coded in different languages, for use with different platforms. In the description that follows, examples of the invention are described in the context of web sites that employ Java Server Pages (JSP) or Active Server Pages (ASP). It will be appreciated, however, that the principles that underlie the invention can be implemented with other types of computer software technologies as well.

In a second embodiment, the present system and method provides a tool that allows non-programmers to create and implement personalized portals for use by potential business prospects.

Additional objects and advantages of the invention will be set forth in part in the description that follows, and in part will be obvious from the description, or may be learned by practice of the invention. The objects and advantages of the invention will be realized and attained by means of the elements and combinations particularly pointed out in the appended claims.

It is to be understood that both the foregoing general description and the following detailed description are exemplary only and not restrictive of the invention as claimed.

### BRIEF DESCRIPTION OF THE DRAWINGS

The accompanying drawings, which are incorporated in and constitute a part of this specification, illustrate exemplary embodiments of the present invention and together with the description, serve to explain the principles of the invention. In the drawings,

FIG. 1 is a block diagram depicting an illustrative system in which the present invention may be practiced;

FIG. 2 is a detailed flowchart of the operation of the present invention;

FIG. 3 is a diagrammatic depiction of a display that may be shown on a user workstation when a user accesses the present invention;

FIG. 4 is a diagrammatic depiction of a display that may be shown on a user workstation in accordance with the present invention when a user selects the Details Tab;

FIG. 5 is a diagrammatic depiction of a display that may be shown on a user workstation in accordance with the present invention when a user selects the Contacts Tab;

FIG. 6 is a diagrammatic depiction of a display that may be shown on a user workstation in accordance with the present invention when a user selects the Notification Tab;

FIG. 7 is a diagrammatic depiction of a display that may be shown on a user workstation in accordance with the present invention when a user selects the Reports Tab;

FIG. 8 is a depiction of a personalized portal page in accordance with one embodiment of the present invention;

FIG. 9 is a depiction of a personalized portal page in accordance with a second embodiment of the present invention; and

FIGS. 10a-10c are reports that may be created in accordance with one embodiment of the present invention.

### DETAILED DESCRIPTION

In the following detailed description of a first embodiment, reference is made to the accompanying drawings that form a part thereof, and in which is shown by way of illustration a specific embodiment in which the invention may be practiced. This embodiment is described in sufficient detail to enable those skilled in the art to practice the invention and it is to be understood that other embodiments may be utilized and that structural changes may be made without departing from the scope of the present invention. The following detailed description is, therefore, not to be taken in a limited sense.

Turning first to the nomenclature of the specification, the detailed description which follows is represented largely in terms of processes and symbolic representations of operations performed by conventional computer components, including a central processing unit (CPU), memory storage devices for the CPU, and connected pixel-oriented display devices. These operations include the manipulation of data bits by the CPU and the maintenance of these bits within data structures residing in one or more of the memory storage devices. Such data structures impose a physical organization upon the collection of data bits stored within computer memory and represent specific electrical or magnetic elements. These symbolic representations are the means used by those skilled in the art of computer programming and computer construction to most effectively convey teachings and discoveries to others skilled in the art.

For the purposes of this discussion, a process is generally conceived to be a sequence of computer-executed steps leading to a desired result. These steps generally require logical manipulations of physical quantities. Usually, though not necessarily, these quantities take the form of electrical, magnetic, or optical signals capable of being stored, transferred, combined, compared, or otherwise manipulated. It is conventional for those skilled in the art to refer to these signals as bits, values, elements, symbols, characters, terms, objects, numbers, records, files or the like. It should be kept in mind, however, that these and similar terms should be associated with appropriate physical quantities for computer operations, and that these terms are merely conventional labels applied to physical quantities that exist within and during operation of the computer.

It should also be understood that manipulations within the computer are often referred to in terms such as adding, comparing, moving, etc. which are often associated with manual operations performed by a human operator. In other words, the operations described herein are machine operations performed in conjunction with a human operator or user who interacts with the computer. The machines used for performing the operation of the present invention include general purpose digital computers or other similar computing devices.

In addition, it should be understood that the programs, processes, methods, etc. described herein are not related or limited to any particular computer or apparatus. Rather, various types of general purpose machines may be used with programs constructed in accordance with the teachings described herein. Similarly, it may prove advantageous to construct specialized apparatus to perform the method steps described herein by way of dedicated computer systems with hard-wired logic or programs stored in nonvolatile memory, such as read only memory.

The operating environment in which the present invention is used encompasses general distributed computing systems wherein general purpose computers, workstations, or personal computers are connected via communication links of various types. In a client server arrangement, programs and data, many in the form of objects, are made available by various members of the system.

The examples described in the text are often accompanied by figures illustrating user interface displays that may be produced through use of a computer system according to the invention to implement the virtual showroom. These too are illustrative and are not intended to limit the invention in any way.

Referring now to the drawings, in which like numerals represent like elements throughout the several figures, the present invention will be described.

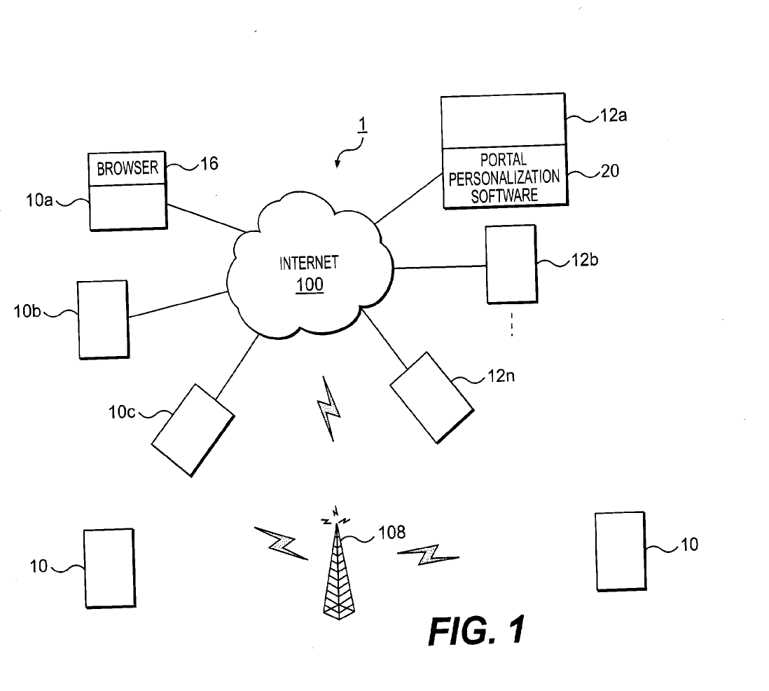

FIG. 1 depicts a representative network environment 1 in which the system and method for providing targeted marketing may be practiced. As shown in FIG. 1, environment 1 is comprised of a network 100, that interconnects plurality of devices 10 including personal computers 10a, workstations 10b, web access devices 10c, and the like, to view informational content provided by various servers 12a-12n. Network 100 can be any network topology commonly known by those of ordinary skill in the art, such as Ethernet, a LAN, WAN, ATM network, or Internet. Network 100 may be implemented using any one or a combination of public packet switched network topologies, such as IEEE 802.3 Ethernet, IEEE 802.5 Token Ring, ITU X.25, or serial (SLIP) protocols, for example. In an exemplary embodiment of the present invention, device 10 may be a web-enabled wireless telephone such as, for example, cellular Code Division Multiple Access (CDMA), Time Division Multiple Access (TDMA), or Global System for Mobil Communication (GSM) telephones that support the Wireless Access Protocol (“WAP”) or i-Mode data access protocols for displaying web application information. Alternatively, device 10 may be wireless Internet-connected personal digital assistants (“PDA”), such as, for example, the Palm VIIx from Palm™ Inc. Devices 10 may also be personal computers capable of accessing network 100 via a protocol such as the Bluetooth protocol, or IEEE 802.11 family of protocols (e.g., WIFO).

Device 10, as further shown in FIG. 1, may interface with a server computer 12 via a wire line interface, or via an access point 108 over a wireless interface. To view the content provided by the server computers 12, devices 10 run a browser application 16. The interface between server 12 and device 10 can be viewed as a client/server model in which the client interface is provided by HTML code generated by the server to run in a user's browser application 16. At servers 12, the available content is stored on suitable storage media, such as magnetic or optical disk drives, in a format that is capable of being read by browser application 16, such as HTML or XML. Typically, each segment of information that can be accessed is referred to as a web page, and has an associated network address. Thus, by entering a particular address in browser application 16, the user is presented with one page of information that is stored on a particular server 12. A collection of web pages that relate to a common topic and are interlinked with one another may form a web site.

Server computers 12 as depicted in FIG. 1 include portal personalization software 20 stored in memory of server 12. In operation, portal personalization software 20 provides the functionality that allows an administrator to dynamically construct and maintain personalized portals in accordance with one embodiment of the present invention. A personalized portal provides content that has been created by a marketer for a specific sales prospect or a small group of sales prospects. In the context of this description, “prospect” is shorthand for prospective customer. In one exemplary embodiment, personalized portals include web links, streaming video, advertisements, online demonstrations, customer stories, press releases and other tailored presentations. To provide this functionality, portal personalization software 20 consists of process management services that are provided by a web server and suitable class libraries. These libraries connect to other servers and use other resources as needed, including a data store which provides object persistence via a suitable database interface. In one exemplary embodiment of the invention, this functionality might be provided by a Java Database Connectivity (JDBC) interface over a Structured Query Language (SQL) database. In another embodiment based upon an Lightweight Direct Access Protocol (LDAP) environment, user management can be provided via Java Naming and Directory Interface (JNDI) over LDAP. The server can connect to other network resources, for example to acquire information from the Internet or an intranet. In an exemplary embodiment, portal personalization software 20 performs two main functions: (1) create/update portal page; and (2) track portal usage.

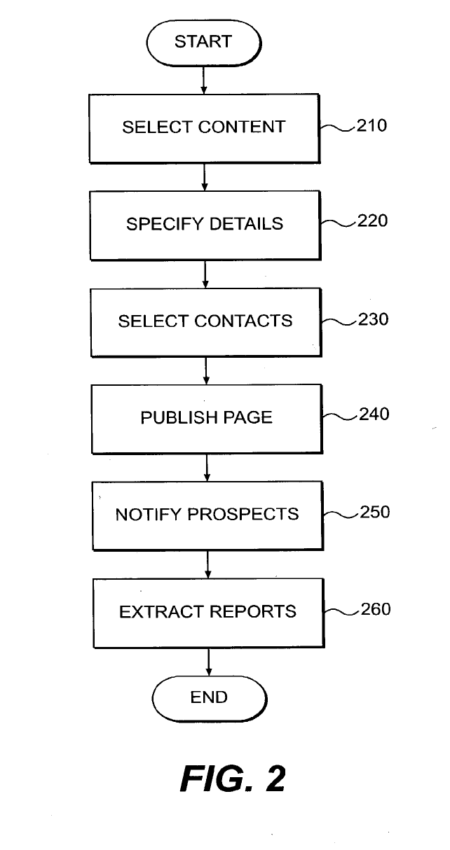

Turning now to FIG. 2, there is shown a detailed flowchart depicting the use and operation of the present invention. In one embodiment software for executing the process depicted in FIG. 2 is loaded into Random Access Memory (RAM) (not shown) in server 12 for execution on the server. As shown in FIG. 2, processing begins in step 210 when a user accesses portal personalization software 20. In one embodiment, a user may access portal personalization software 20 by logging onto a corporate web site associated with portal personalization software 20. Alternatively, a user (or portal designer) may log onto a dedicated portal personalization software site, or performs any number of prior art methods for executing a software system. Once the user accesses the site, processing flows to step 220 where the user selects the content for the portal. This includes selecting the organization that will have access to the portal and the content that will be made available to those who may access the portal. Processing then flows to step 230 where the details are specified. In this step, the user organizes the information on the portal page for display to the end user. Processing then flows to step 230 where the user selects the actual contacts or individuals who will have access to the portal. The portal is published in step 240, and in step 250, the user is able to notify potential prospects that the portal page has been created. Processing next flows to step 260 where the user may identify reports that will be obtained by server 12 and reported back to the user.

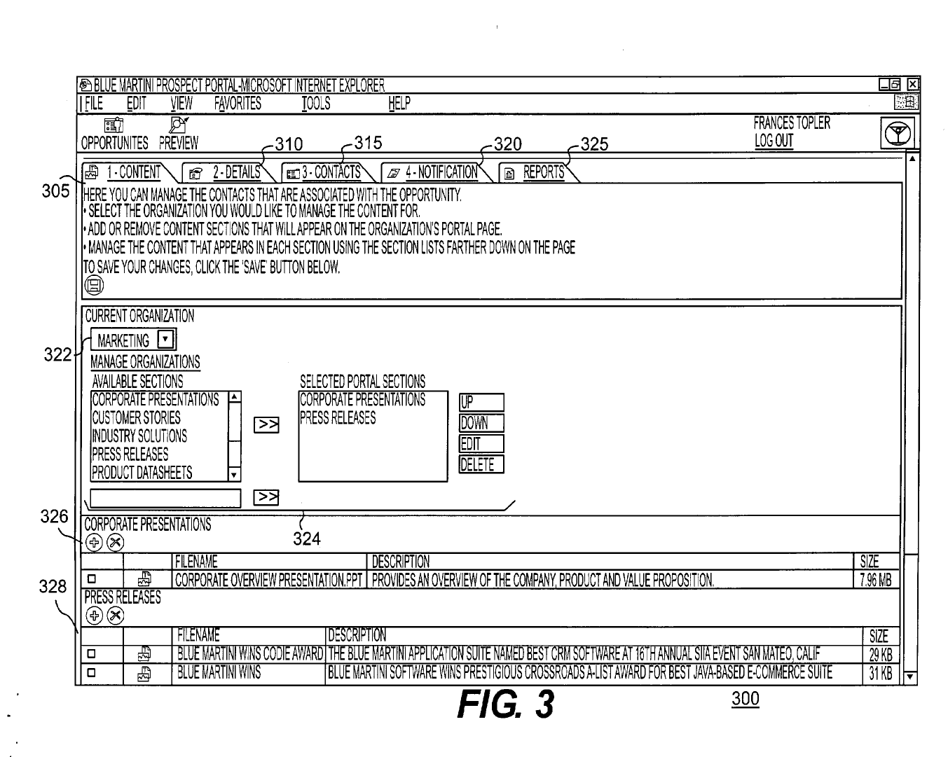

Referring now to FIG. 3, there is shown one exemplary embodiment of a page that may be displayed on the user's display device (not shown) when the user accesses portal personalization software 20. As shown in FIG. 3, web page 300 consists of images, text and at least one data entry area. More specifically, web page 300 consists of a plurality of tabs (Content 305, Details 310, Contacts 315, Notification 320, and Reports 325). Moving from left to right, it is shown that content tab 305 has an Organization pull-down menu 322, an available/selected sections 324, and one or more listings of corporate collateral 326 and 328. To create a personalized portal, a marketer first uses pull-down menu 322 to select the organization to be associated with the portal page (e.g., marketing, technical, organizational, etc.) By selecting one or more organizations, a user is able to create unique portals for one or more members of the audience who have similar informational interests, and still maintain the association with the targeted audience. For example, Information Technology (IT) may only want to see Architecture and Implementation documents, Marketing would like to see customer stories, and the Executive team may want to see financials. Once the organization is selected, the marketer may then select the sections he/she would like included in the personalized portal from the available/selected sections 324. Associated with each available section is a listing of corporate collateral that the marketer may select to be added to the prospect's personalized portal. More specifically, the marketer may create the portal page by identifying the category of the page and selecting press releases, advertisements, corporate presentations, demos, tailored presentations and streaming video to include on the page. By selecting the content, the marketer is setting the upper limit on the information that will be accessible to the end user. In other words, the end user may only look at the selections identified. He/she does not have to look at all the identified selections, but he/she may not look at any selections that were not previously selected by the marketer. In this way, the marketer limits the extraneous information that an end user is exposed to, and therefore may access. By streamlining the process of exchanging information between marketers and prospects, the present invention improves the prospect's data gathering experience by reducing the amount of irrelevant information to which a prospect is exposed.

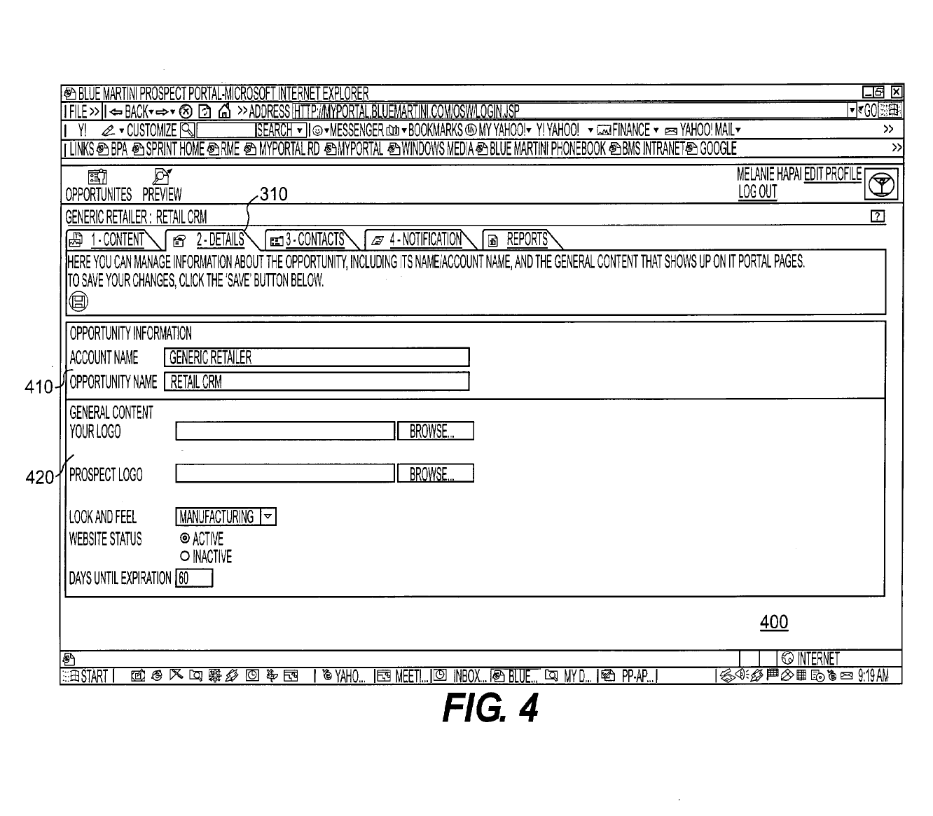

Referring now to FIG. 4, there is shown a page 400 that may be displayed to the user when step 220 (FIG. 2) is executed. This step may be performed when a user selects Details tab 310 (FIG. 3). In this step, the marketer organizes the information on the portal page for display to the end user by setting locations on the page for the selected information, assigning styles to elements of the page, including appearance settings, such as fonts and color. As shown, Page 400 consists of a data entry area for Opportunity Information 410 and a data entry area for General Content 420. After identifying the information to be placed on the portal page, server 12 then converts the information into a format that is compatible with all of the various types of device 10. One of the significant advantages of the portal framework of the present invention is the fact that the resources that are made available to the user via the modules can come from a variety of third-party sources. Consequently, however, the content for the modules may be largely unstructured, which can be problematic when it is to be made available for manipulation and display within the portal. To this end, therefore, a parsing technology is employed for retrieving data from external web sites and various other sources, translating the data into XML or other compatible format, and returning structured results as objects for use by other entities, such as modules.

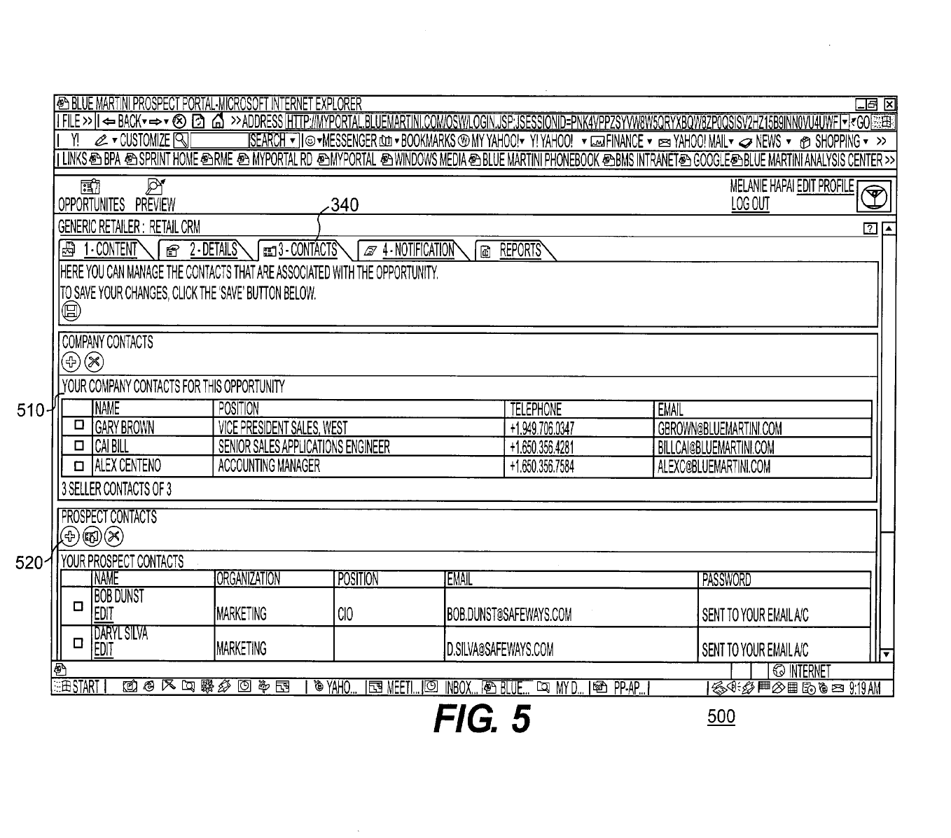

Referring now to FIG. 5, there is shown a page 500 that may be displayed to the user when step 230 (FIG. 2) is executed. This step may be performed when a user selects Contacts tab 315 (FIG. 3). By pressing the Contacts tab 315, the marketer is given the opportunity to identify the users who will have access to the page. As shown, page 500 consists of a data entry area for Company Contacts 510, and a data entry area for Prospect Contacts 520. Company Contacts are those individuals in the user's organization who should have access to the portal, and Prospect Contacts are those outside prospects who should have access to the portal. Once the users/prospects have been identified, the administrator is then permitted to publish the page (Step 240), making it available to one or more users and/or user groups.

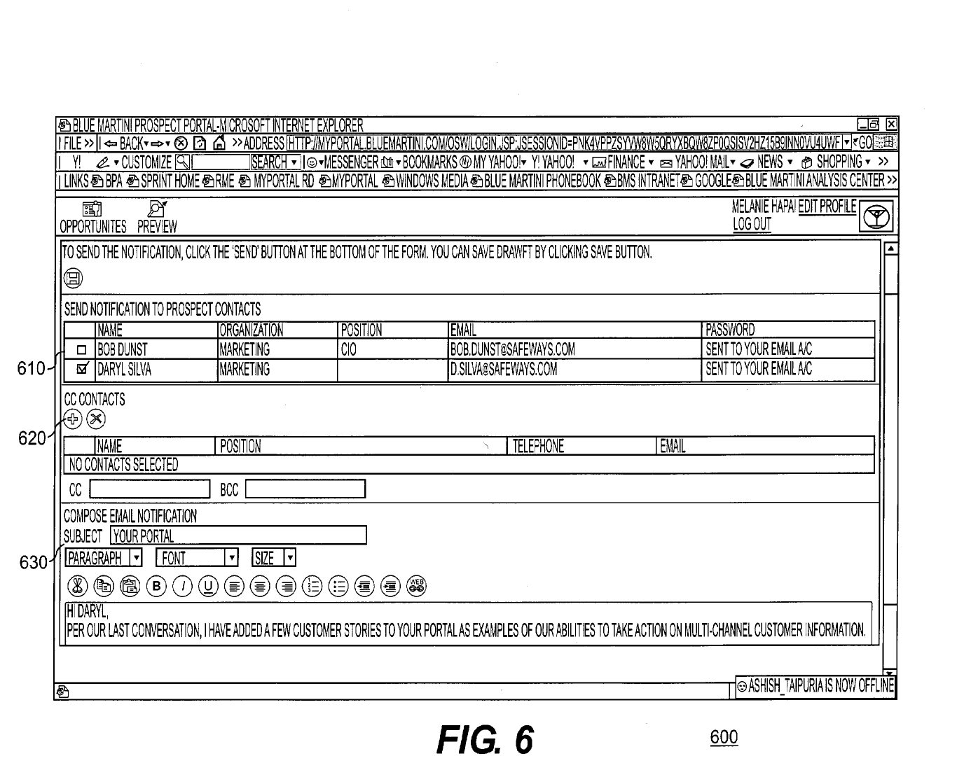

After the page has been published, the marketer then presses the “Notification” tab 350 to notify the users that the portal page has been created (step 250). Turning now to FIG. 6, there is shown a page 600 that may be displayed to the user when step 250 (FIG. 2) is executed. This step may be performed when a user selects Notification tab 320 (FIG. 3). By pressing the Notification tab 320, the marketer is given the opportunity to identify the users who will have access to the page and to send messages to them. As shown, page 600 consists of a data entry area for Addressees 610, a data entry area for CC'd (copied) contacts 620, and a data entry area for Composing an email notification 630. In one embodiment of the present invention, the user may still add, modify and delete content on the portal without impacting the currently-online users.

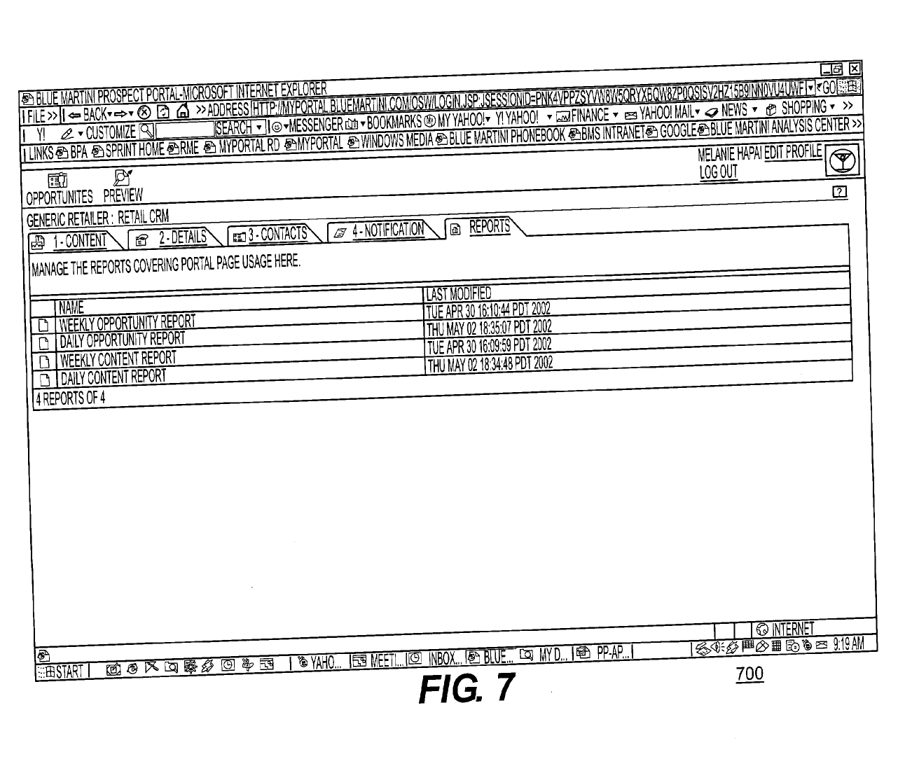

The final tab on web page 310 is the “Reports” tab 325. Selecting this tab allows the marketer to select specific reports and other statistical data that will be obtained by server 12 and reported back to the marketer. Referring to FIG. 7, there is shown a page 700 that may be displayed to the user when step 260 (FIG. 2) is executed. This step may be performed when a user selects Reports tab 325 (FIG. 3). By pressing the Reports tab 320, the marketer is given the opportunity to select reports she would like to access. As shown, page 700 consists of a listing of available reports.

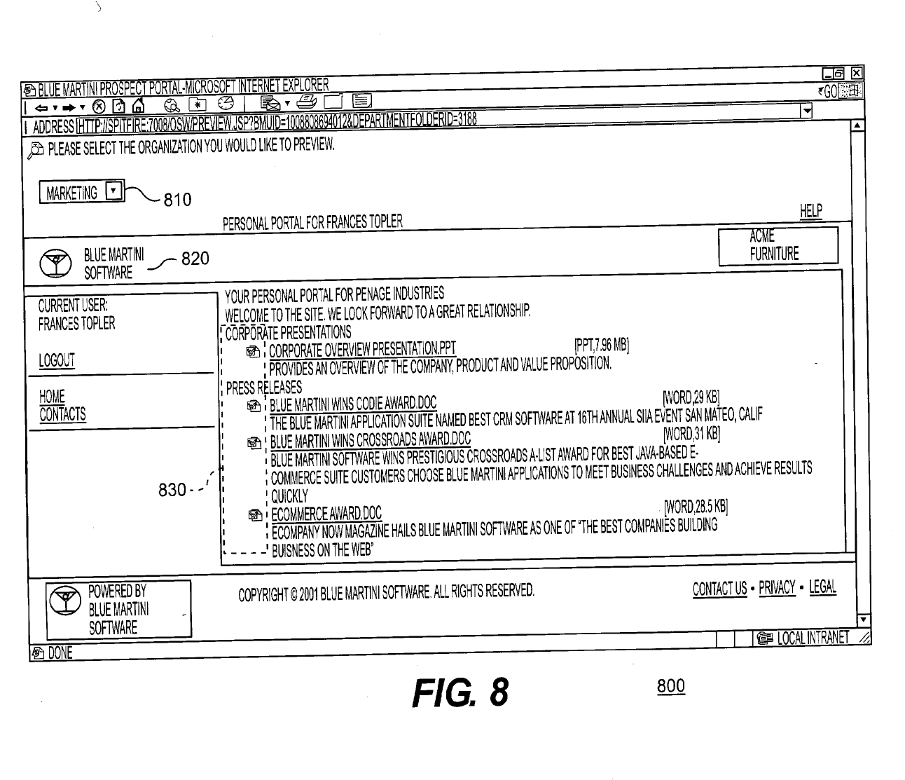

Referring now to FIG. 8, there is shown an example of a personalized portal page 800 in accordance with an exemplary embodiment of the present invention. In one exemplary embodiment, a user will first navigate to a corporate web site that includes a button that allows the user to jump to portal page 800. In an alternate embodiment, a user may enter a web address that immediately routes the user to portal page 800. In yet another embodiment, access to portal page 800 may be determined from a cookie received from a user operating device 10. In other words, identifying information about registered site users may be stored in a database associated with server 12. A registration page enables new users to be added to the database; and a login page enables users to identify themselves to server 12 by entering their user name and password. The login information may be stored as a browser cookie so that users don't have to log in each time they visit a site. In operation, when a user accesses the corporate web site or portal site, server 12 checks for a cookie identifying the user. If no cookie is found, server 12 may send one to browser 16 when a registered user logs in. If a user is identified as a registered user, server 12 identifies a personalized portal page 800 associated with the user and then transmits the appropriate page to device 10 for display. If a user is identified as an unauthorized user or an unregistered user, the user will only be given access to the standard corporate web site. A site may change this behavior through portal server scripting pages—for example, to send unregistered users to another site.

As shown, portal page 800 may include a pull-down menu 810 that allows an end user to select the organization (e.g., marketing, technical, organizational, etc.) he/she would like to preview. Below pull-down menu 810, there is shown a suitable banner 820 containing a corporate logo or the like, and one or more navigation buttons 830 or links that permit the user to access content that has been identified by a marketer as useful for the purpose of developing the prospect. In the illustrated example, the personalized material includes a corporate presentation and several press releases. As shown, the personalized material includes a title of the presentation, the application that hosts the presentation (PPT, Word, Excel, etc.) and the size of the presentation. The material may, as described above, also include advertisements, demos, tailored presentations, web links and video streams.

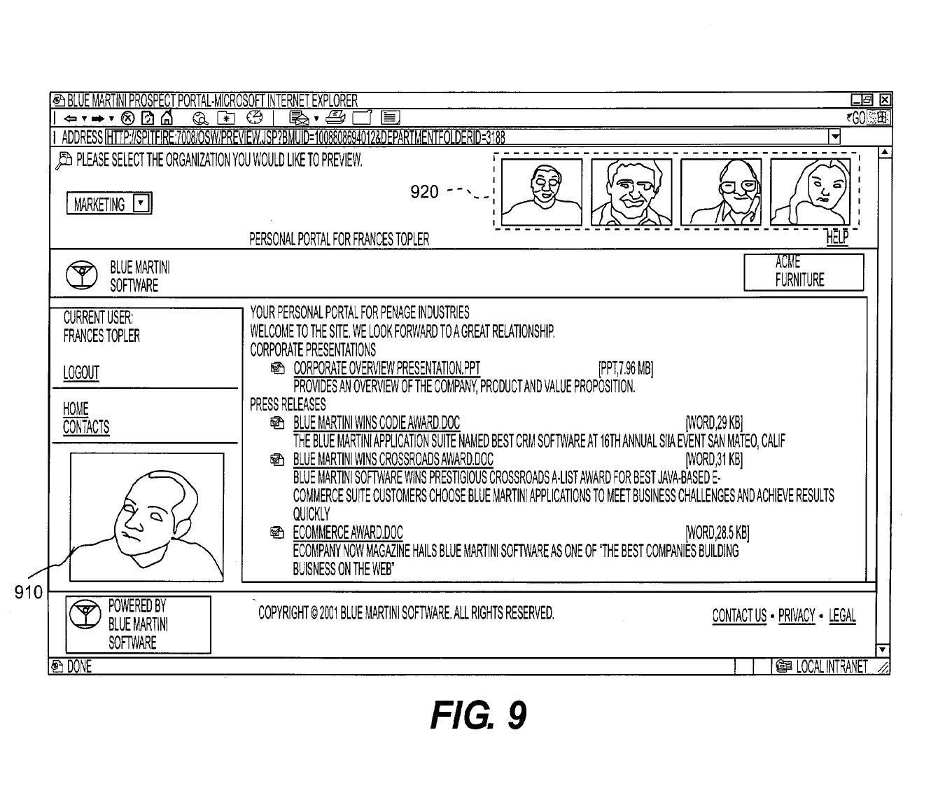

Referring to FIG. 9, there is shown an alternate embodiment of the present invention in which a user may additionally be permitted to participate in a live collaboration with one or more other users. Web page 900 as shown includes a window for displaying the face of the registered user 910, and the faces of one or more other users 920. Device 10 may include a video camera, speakers and a microphone (not shown) to additionally provide the capability for collaborators to participate in a virtual meeting.

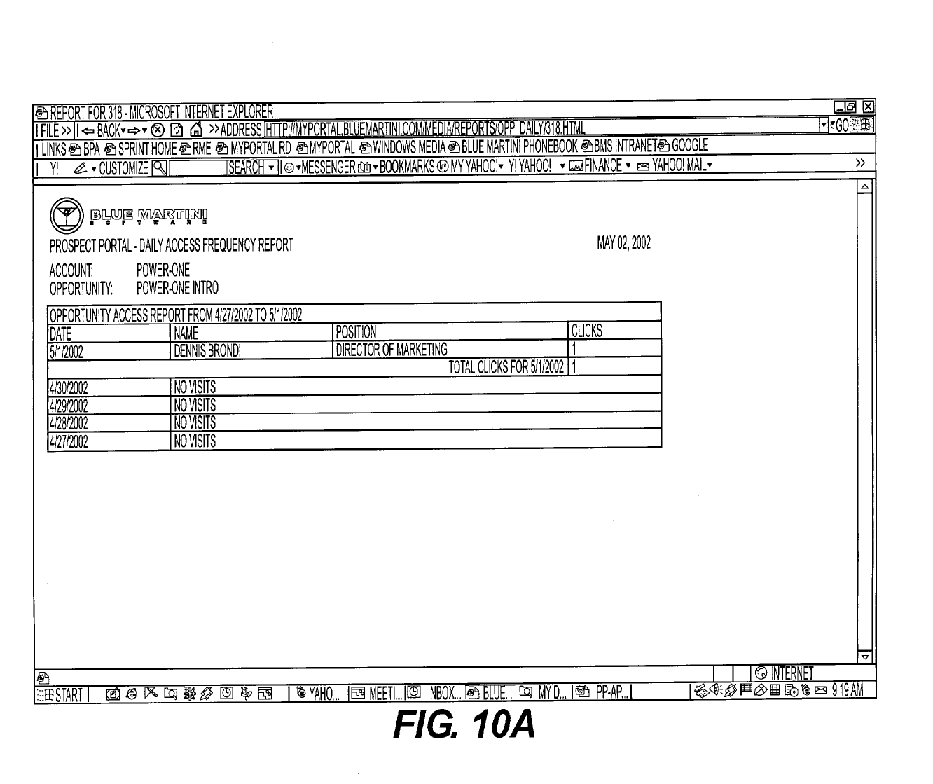

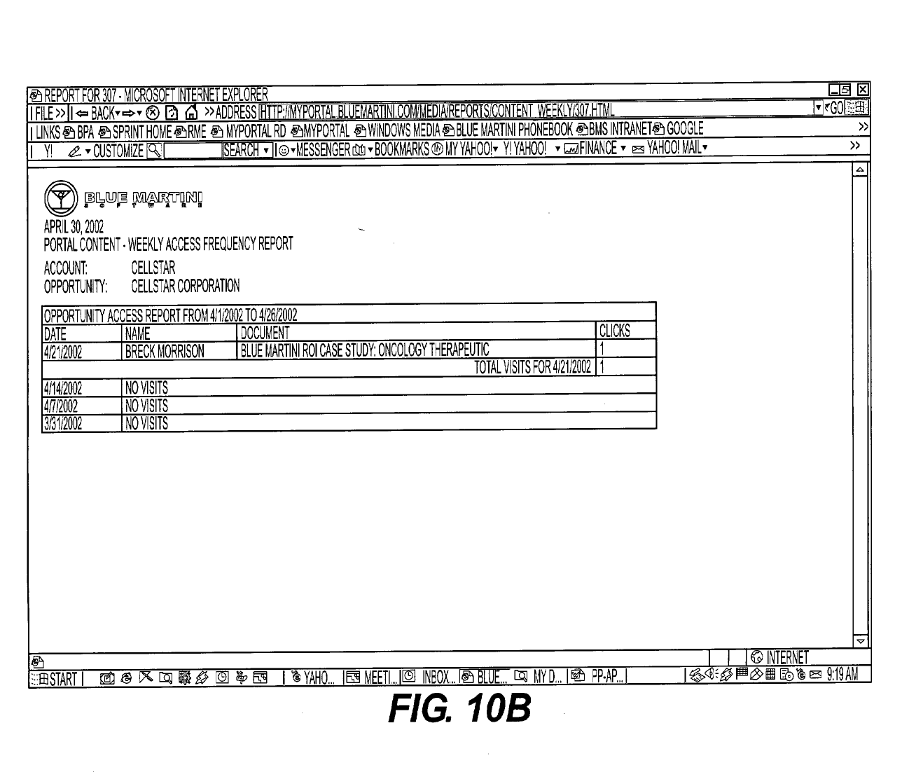

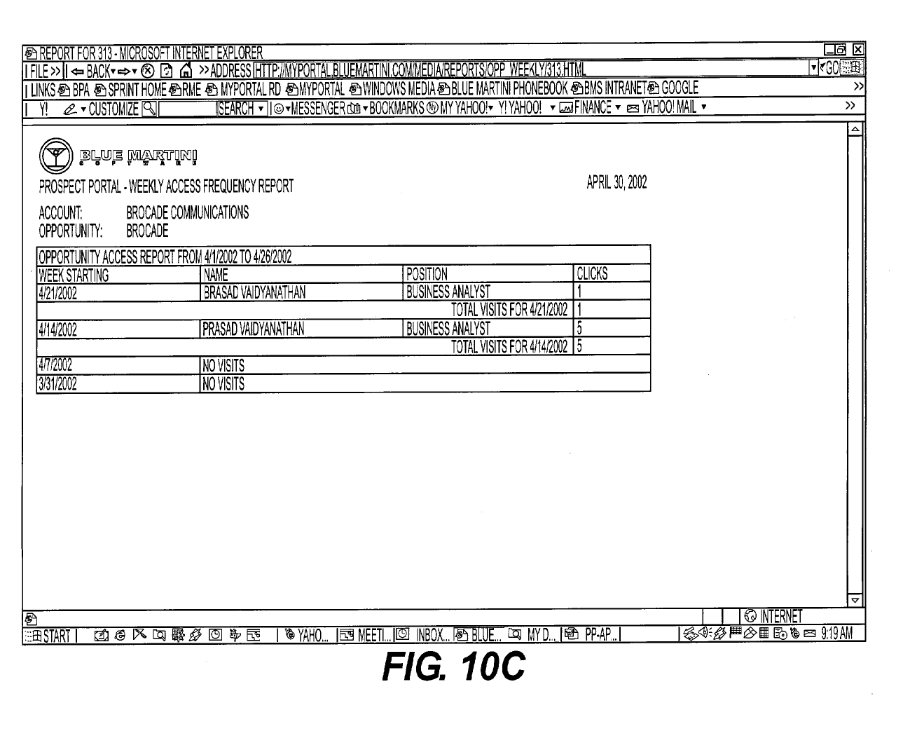

When a user selects one or more content items from web pages 800 and 900, server 12 may populate a report representative of the user's activities while on the site. For example, information may be collected on server 12 that associates each user with the content selected by the user, the amount of time that the user reviewed the content, any other users that participated in live collaboration with the user while the content was being reviewed, etc. A report of the user's actions may be compiled and presented to a marketer or other person associated with the corporate site for review and analysis. Referring to FIGS. 10a-10c, there are shown several reports that may be generated by one exemplary embodiment of the present invention. As shown, the reports may include spreadsheet data and graphical charts, and they may be compiled and printed daily, weekly, bi-weekly, monthly, etc. The data may also be organized by document, user, organization, position, etc.

In the event that the user accesses web pages 800 and 900 from a thin computing device (e.g., PDA, cellular telephone, etc.), one embodiment of the present invention will modify the output from server 12 to accommodate the reduced processing capabilities of the thin computing device. For example, if a user accesses server 12 using his/her PDA over a wireless interface, server 12 may display the fact that a streaming video presentation is available for viewing, but if the user selects the icon associated with the streaming video, server 12 may transmit a message to the PDA informing the user that the streaming video may not be previewed on the PDA due to the reduced capabilities. On the other hand, a video may be transmitted to the user that is of lower resolution and quality. Examples of different known formats include, but are not limited to plain text, VoxML, HDML, audio, video, etc.

From the foregoing description, it will be appreciated that the present invention provides an efficient system and method for providing a personalized portal to a prospect. The present invention has been described in relation to particular embodiments which are intended in all respects to be illustrative rather than restrictive. Those skilled in the art will appreciate that many different combinations of hardware will be suitable for practicing the present invention. Many commercially available substitutes, each having somewhat different cost and performance characteristics, exist for each of the components described above.

Despite the fact that aspects of the present invention are described as being stored in memory, one skilled in the art will appreciate that these aspects can also be stored on or read from other types of computer-readable media, such as secondary storage devices, like hard disks, floppy disks, or CD-ROMs; a carrier wave from the Internet; or other forms of RAM or ROM. Similarly, the method of the present invention may conveniently be implemented in program modules that are based upon the flow chart in FIG. 2. No particular programming language has been indicated for carrying out the various procedures described above because it is considered that the operations, steps and procedures described above and illustrated in the accompanying drawings are sufficiently disclosed to permit one of ordinary skill in the art to practice the instant invention. Moreover, there are many computers and operating systems which may be used in practicing the instant invention and, therefore, no detailed computer program could be provided which would be applicable to these many different systems. Each user of a particular computer will be aware of the language and tools which are most useful for that user's needs and purposes.

Alternative embodiments will become apparent to those skilled in the art to which the present invention pertains without departing from its spirit and scope. Accordingly, the scope of the present invention is defined by the appended claims rather than the foregoing description.

What is claimed is:

1. A method comprising:
providing customized content to at least one prospective customer by selecting a category for the customer, where the category indicates an informational interest of the customer, said informational interest being based on said category;
using said category, using a computer for creating a personalized web page by aggregating plural items of information relevant to said informational interest, where first customer s with a first informational interest from a first category are offered a first set of items of information comprising said web page, and second customers with a second informational interest from a second category are offered a second set of items of information comprising said web page different than the first set of items of information, and where said first customers with a first informational interest are prevented from accessing said second set of items of information, and said second customers with said second informational interest are prevented from accessing said first set of items of information;
based on a request from the customer, providing the personalized web page to the prospect such that said first customers receive a different web page than said second customers;
monitoring actions taken by the customers on the web page, including monitoring which of said first set of items of information are accessed by the first customer and separately monitoring which of said second set of items of information are accessed by the second customer and gathering behavior data based on said monitoring; and
modifying the first set of items of information and said second set of items of information based on said behavior data to create a first modified set of information for customers with said first informational interest and to create a second modified set of information for customers with said second informational interest and creating a modified web page for said first customer based on said modified first set of items of information, and creating a modified web page for said second customer based on said modified second set of items of information.

2. The method of claim 1, further comprising granting access to a user if the user has proper identification information.

3. The method of claim 1, wherein the modifying further comprises: determining aggregated information that has a positive impact on the prospect; and including the aggregated information that has a positive impact in portal pages for subsequent prospects.

4. The method of claim 1, wherein the modifying further comprises: determining aggregated information that has a negative impact on the prospect; and excluding the aggregated information that has a negative impact from future portal pages.

5. The method of claim 1, wherein the prospect behavior data comprises: an identity of a prospect; an identity of a web page visited by the prospect; and a number of times the prospect visited the web page.

6. An apparatus for providing customized content to at least one prospective customer, the apparatus comprising:
a web server, controlling selection of a category for the customer, where the category indicates an informational interest of the customer, said informational interest being based on said category, said web server creating a personalized web page by aggregating plural items of information relevant to said informational interest, where first customer s with a first informational interest from a first category are offered a first set of items of information comprising said web page, and second customers with a second informational interest from a second category are offered a second set of items of information comprising said web page different than the first set of items of information, and where said first customers with a first informational interest are prevented from accessing said second set of items of information, and said second customers with said second informational interest are prevented from accessing said first set of items of information, said web server, said web server providing the personalized web page to the prospect such that said first customers receive a different web page than said second customers; said web server monitoring actions taken by the customers on the web page, including monitoring which of said first set of items of information are accessed by the first customer and separately monitoring which of said second set of items of information are accessed by the second customer and gathering behavior data, and modifying the first set of items of information and said second set of items of information based on said behavior data to create a first modified set of information for customers with said first informational interest and to create a second modified set of information for customers with said second informational interest and creating a modified web page for said first customer based on said modified first set of items of information, and creating a modified web page for said second customer based on said modified second set of items of information.

7. The apparatus of claim 6, wherein the web server grants access to a user if the user has proper identification information.

8. The apparatus of claim 6, wherein web server determines the aggregated information that has a positive impact on the prospect; and means for including the aggregated information that has a positive impact in portal pages for subsequent prospects.

9. The apparatus of claim 6, wherein the web server determines the aggregated information that has a negative impact on the prospect; and means for excluding the aggregated information that has a negative impact from future portal pages.

10. The apparatus of claim 6, wherein the prospect behavior data comprises: an identity of a prospect; an identity of a web page visited by the prospect; and a number of times the prospect visited the web page.

11. A computer-readable medium containing instructions executable by a computer to direct customized content to at least one prospective customer, the method comprising:
providing customized content to at least one customer by selecting a category for the prospective customer, where the category indicates an informational interest of the customer, said informational interest being based on said category;
using said category, creating a personalized web page by aggregating plural items of information relevant to said informational interest, where first customer s with a first informational interest from a first category are offered a first set of items of information comprising said web page, and second customers with a second informational interest from a second category are offered a second set of items of information comprising said web page different than the first set of items of information, and where said first customers with a first informational interest are prevented from accessing said second set of items of information, and said second customer s with said second informational interest are prevented from accessing said first set of items of information;
based on a request from the customer, providing the personalized web page to the prospect such that said first customers receive a different web page than said second customers;
monitoring actions taken by the customers on the web page, including monitoring which of said first set of items of information are accessed by the first customer and monitoring which of said second set of items of information are accessed by the second customer and gathering behavior data based on said monitoring; and
modifying the first set of items of information and said second set of items of information based on said behavior data to create a first modified set of information for customers with said first informational interest and to create a second modified set of information for customers with said second informational interest and creating a modified web page for said first customer based on said modified first set of items of information, and creating a modified web page for said second customer based on said modified second set of items of information

12. The computer-readable medium of claim 11, further comprising granting access to a user if the user has proper identification information.

13. The computer-readable medium of claim 11, wherein modifying further comprises: determining aggregated information that has a positive impact on the prospect; and including the aggregated information that has a positive impact in portal pages for subsequent prospects.

14. The computer-readable medium of claim 11, wherein modifying further comprises: determining aggregated information that has a negative impact on the prospect; and excluding the aggregated information that has a negative impact from future portal pages.

15. The computer-readable medium of claim 11, wherein the prospect behavior data comprises: an identity of a prospect; an identity of a web page visited by the prospect; and a number of times the prospect visited the web page.

16. A method as in claim 1, further comprising generating a report based on the prospect behavior data.

17. A method as in claim 1, wherein said monitoring actions comprises monitoring an amount of time that a document was reviewed by a viewer.

18. An apparatus as in claim 6, wherein said web server generates a report based on the prospect behavior data.

19. An apparatus as in claim 6, wherein said web server monitors an amount of time that a document was reviewed by a viewer.

20. A medium as in claim 11, further comprising instructions for generating a report based on the prospect behavior data

21. A medium as in claim 11, wherein said monitoring actions comprises monitoring an amount of time that a document was reviewed by a viewer.
